(19) United States
(12) Patent Application Publication
(10) Pub. No.: US 2008/0270172 A1
(43) Pub. Date: Oct. 30, 2008

(54) METHODS AND APPARATUS FOR USING RADAR TO MONITOR AUDIENCES IN MEDIA ENVIRONMENTS

(76) Inventors: Robert A. Luff, Wittman, MD (US); John W. Buonasera, Largo, FL (US); Stanley F. Seagren, Cortlandt Manor, NY (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/166,955

(22) Filed: Jul. 2, 2008

Related U.S. Application Data
(63) Continuation of application No. PCT/US2007/063866, filed on Mar. 13, 2007.
(60) Provisional application No. 60/781,625, filed on Mar. 13, 2006.

(51) Int. Cl. G06Q 99/00; G01S 13/00

(52) U.S. Cl. 705/1; 342/146

(57) ABSTRACT

Methods and apparatus for using radar to monitor audiences in media environments are described. An example method of identifying media exposure acquires radar information associated with a person in a media environment, determines a location of the person in the media environment based on the radar information, and identifies media exposure based on the location of the person

### RELATED APPLICATIONS

This application is a continuation of International Patent Application No. PCT/US2007/063866, filed on Mar. 13, 2007, which claims the benefit of the filing date of U.S. Provisional Application No. 60/781,625, filed on Mar. 13, 2006, the entire disclosures of which are incorporated herein by reference.

### FIELD OF THE DISCLOSURE

The present disclosure relates generally to collecting audience measurement data and, more specifically, to methods and apparatus for using radar to monitor audiences in media environments.

### BACKGROUND

Successful planning, development, deployment and marketing of products and services depend heavily on having access to relevant, high quality market research data. Companies have long recognized that improving the manners in which marketing data is collected, processed and analyzed often results in more effective delivery of the right products and services to consumers and increased revenues.

Audience measurement data is an important type of market research data that provides valuable information relating to the exposure and consumption of media programs such as, for example, television and/or radio programs. Audience measurement companies have used a variety of known systems to collect audience measurement data associated with the consumption patterns or habits of media programs. As is known, such audience measurement data can be used to develop program ratings information which, in turn, may be used, for example, to determine pricing for broadcast commercial time slots.

Collecting audience measurement data in certain media environments such as, for example, households (i.e., homes, apartments, condominiums, etc.) can be especially challenging. More specifically, audience members within a household may move quickly from room to room, and many rooms within the household may contain media presentation devices (e.g., televisions, radios, etc.) that are relatively close to one another. For example, a single media space (e.g., a family room) within the household may contain one or more televisions and/or radios in close proximity. Further, different media spaces within the household may contain respective media presentation devices that are relatively close to each other (e.g., on opposing sides of a wall separating the media spaces).

In some media environment metering systems (e.g., indoor systems for use in buildings such as households or other structures), a stationary metering device is placed in proximity to each media presentation device to be monitored. Persons entering a space with a monitored media presentation device may be automatically recognized (e.g., using a line-of-sight based sensing technology, and/or another technology) and logged as actively consuming the program(s) presented via the media presentation device. Alternatively or additionally, the persons entering the space may indicate their presence to the stationary metering device by pressing a button corresponding to their identity or otherwise manually indicating to the stationary meter that they are present. Of course, systems employing only such stationary metering devices cannot meter media spaces within the monitored environment that do not have a stationary meter. Additionally, the stationary devices often have difficulty identifying persons in the metered space due to limitations of the sensing technologies used and/or the failure of persons to comply with identification procedures (e.g., manual pressing of buttons or entering of data to indicate their presence).

Still other media environment metering systems use portable media meters (PPM's) instead of or in addition to stationary metering devices to meter the media consumption of persons within a monitored media environment. Such PPM's may be attached (e.g., belt worn) or otherwise carried by a monitored individual to enable that person to move from space to space within, for example, a household and collect metering data from various media presentation devices. Such PPM-based systems are passive in nature (i.e., the systems do not necessarily require the monitored person to manually identify themselves in each monitored space) and can enable better or more complete monitoring of the media environment. However, the relatively proximate relationship between the media presentation devices within a typical media environment such as a household can often result in effects such as spillover and/or hijacking, which result in incorrect crediting of media exposure or consumption. Spillover occurs when media delivered in one area infiltrates or spills over into another area occupied by monitored individuals who are not actively or intentionally consuming that media. Hijacking occurs when a monitored person is exposed to media signals from multiple media delivery devices at the same time For example, an adult watching the news via a television in the kitchen may be located near to a family room in which children are watching cartoons. In that case, a metering device (e.g., a PPM) carried by the adult may receive stronger (e.g., code rich) audio/video content signals that overpower or hijack the sparse audio/video content (e.g., audio/video content having a relatively low code density) that the adult is actively and intentionally consuming. Additionally, compliance is often an issue because monitored persons may not want to or may forget to carry their PPM with them as they move throughout their household.

Still other metering systems use passive measurement techniques employing reflected acoustic waves (e.g., ultrasound), radio frequency identification (RFID) tag-based systems, etc. to meter the media consumption of persons within a monitored media environment such as a household. However, systems using reflected acoustic waves typically require a relatively large number of obtrusive acoustic transceivers to be mounted in each monitored space within the media environment (e.g., each monitored room of a household). Systems employing such acoustic transceivers typically have numerous dead spaces or dead zones and, thus, do not enable substantially continuous, accurate tracking of persons as they move throughout the monitored environment. Further, as is the case with PPM-based systems, tag-based systems such as RFID systems requires persons to wear a tag or other RFID device at all times and, thus, these systems are prone to compliance issues.

### BRIEF DESCRIPTION OF THE DRAWINGS

FIG. 1 depicts an example media environment having an example radar-based system to collect audience measurement data.

FIG. 2 is an example media environment that may be monitored using the example radar-based system described in connection with FIG. 1.

FIG. 2A depicts example coverage zones for the example media environment of FIG. 2.

FIGS. 2B and 2C depict other example coverage zones or patterns that may be used to implement the example radar-based audience measurement systems described herein.

FIG. 3 depicts an example representation of a radar map of the example media environment of FIG. 2 in an unoccupied condition.

FIG. 4 depicts an example of a sequence of representations of radar maps of the occupied media environment of FIG. 2 from which the example map representation of FIG. 3 has been subtracted to leave radar images including clusters or blobs representing the locations of the occupants.

FIG. 5 is a flow diagram depicting an example process that may be used to install the example radar-based audience measurement systems described herein.

FIG. 6 is a flow diagram depicting an example process that may be used in the example radar-based audience measurement systems described herein to track audience members.

FIG. 7 is a flow diagram depicting in more detail the example map generation process of FIG. 6.

FIG. 8 is a flow diagram depicting in more detail the example process for identifying unknown persons of FIG. 6.

FIG. 9 is a flow diagram depicting in more detail the example process for associating media cells with persons of FIG. 6.

FIG. 10 is a flow diagram depicting in more detail the example process for logging in a new occupant of FIG. 8.

FIG. 11 is a flow diagram depicting in more detail the example process for manually logging in a person of FIG. 10.

FIG. 12 is a block diagram of an example radar-based system that may be used to implement the example radar-based audience measurement apparatus and methods described herein.

FIG. 13 is example processor-based system that may be used to implement the example radar-based audience measurement apparatus and methods described herein.

FIG. 14 is a block diagram of another system that may be used to implement the example radar-based audience measurement apparatus and methods described herein.

### DETAILED DESCRIPTION

In general, the example methods, apparatus, and articles of manufacture described herein use radar-based systems and techniques to generate audience measurement data by substantially continuously tracking the locations and movements of persons (e.g., audience members) within monitored media environments (e.g., households) and associating the tracked locations with active media cells or spaces within the monitored environments. When a person's location is associated with an active media cell or space, credit for exposure and/or consumption of the media (e.g., television programs, radio programs, live presentations, etc.) being presented in that active cell may be logged or given. Alternatively or additionally, a person's tracked locations may be non-media cell related information such as, for example, the manner in which the person's movements within the media environment are related to exposure to certain types of media (e.g., commercials). For instance, the number of times a person travels to a refrigerator in response a particular commercial and/or the type of food product taken from the refrigerator may be determined and analyzed.

More specifically, the examples described herein sub-divide a media environment (e.g., a household, a retail store, etc.) to be monitored into a plurality of media cells, each of which may be defined to be an area surrounding a media presentation device such as a television or radio. One or more radar devices (e.g., ultra wideband receivers, transmitters, and/or transceivers) disposed in the media environment are used to generate radar images of the media cells. For each cell, a background or reference image including substantially only fixed objects such as furniture, accessories, equipment, etc. is subtracted from images generated while persons occupy the monitored media environment. Other non-human activity (e.g., animals, pets, etc.) may also be subtracted or otherwise eliminated as possible human activity by using radio frequency identifier tags attached to the non-human occupants and eliminating locations/movements associated with the tags. Likewise, other non-human movement(s) associated with, for example, moving objects such as drapes, fans, doors, etc. may be identified and ignored or subtracted from radar information gathered while monitoring occupants in the media environment. While tags may be used to eliminate or to ignore non-human activity, analysis of the movements (e.g., gait or other movement analysis) of objects and/or noise signatures of the objects may be used to identify non-human movements or activity without having to employ tags. Still further, radar images or blobs that appear to be related to human activity but which may suddenly appear within the monitored media environment and which are not identified may be ignored or eliminated from consideration when producing difference images or occupant maps. In any event, difference images including patterns (e.g., blob-shaped radar images or clusters) representative of persons to be monitored can then be used to identify the current locations of persons within the monitored environment. Such difference images can be repeatedly (e.g., periodically) generated to track the motion, movements, paths of travel, etc. of persons within the environment.

The movement or location data provided by the difference images are associated with the predefined media cells to determine within which, if any, media cell(s) persons are located. Certain spaces, such as, for example, hallways, closets, etc., and spaces not having a media presentation device or another type of media event (e.g., a live media event), are not considered media cells. Thus, over time, a person's location may be associated with one or more media cells and/or other non-media cell locations within the monitored media environment (e.g., a household, retail store, etc.). Non-media locations may include certain areas within which movement should be ignored. For example, a hamster cage, a crib, or any other area in which movement would likely be associated with a person, animal, etc. that would not be capable of consuming media. Additionally, the status of the media presentation devices or other type of media event(s) in each media cell is monitored to determine whether the cell is active (i.e., the media presentation device is on and presenting media or another type of media event is occurring) or inactive (i.e., the media presentation device is off or otherwise not presenting media in a consumable manner or another type of media event is not occurring). Thus, if a person's location is determined to be in a currently active media cell, then that person may be considered to be exposed to and likely consuming the media being presented and appropriate audience measurement data reflecting that consumption is generated. Certain media cells containing, for example, printed media such as advertisements or the like, may be considered continuously active.

Further, identifying tags similar to those mentioned above may alternatively or additionally be used to tag equipment or devices within the monitored media environment to enable an identification of who is using the equipment and/or devices in connection with consuming media (e.g., watching television). For example, remote controls (e.g., for a television, stereo, DVD player, etc.), game controls (e.g., video game controls), laptop computers, etc. may be tagged so that use of these devices can be associated with particular persons in connection with their consumption of media within the monitored media environment. Also, household appliances such as, for example, a refrigerator, a microwave, etc. may be tagged to enable, for example, analysis of what activities individuals perform during their consumption of media. In one particular example, tagging of appliances may enable an analysis of the activities of individuals during commercial breaks (e.g., preparing food, multi-tasking, etc.).

The persons associated with the radar patterns, clusters, or blobs generated in the difference images noted above can be identified, re-identified, and/or have their identities confirmed or verified in several manners. For example, a person may be identified upon entry to a monitored media environment (e.g., at an entry portal to a household). In particular, a person entering the media environment may be asked to manually enter their identity via an input device such as a keypad and/or via a biometric input device such as, for example, a fingerprint or retinal scanner, a voice recognition system, a gait detection system, their height and/or weight, etc. Alternatively or additionally, a person's identity may be automatically determined (i.e., in a completely passive manner requiring no manual input or other effort by the person) using a stored biometric profile. More specifically, one or more of the radar devices (e.g., receivers, transmitters, and/or transceivers) may identify a person (i.e., may capture a blob or other pattern or image representative of or corresponding to that person) upon or immediately prior to the person entering the monitored environment. A heart rate, a breathing pattern, and/or other biological, physiological, or physical characteristic information may be determined from the radar image and compared to previously stored profile information (e.g., a biometric profile). If a matching profile is found, the system may assume and/or may request confirmation that the identity associated with the matching biometric profile information is the identity of the person entering the media environment.

Once an identity has been associated with a radar pattern, image, or blob associated with a person entering the monitored media environment, the person can be tracked as they move throughout the monitored environment without requiring the person to identify themselves as they move within and into and out of (i.e., among) the various media cells within the monitored environment. If tracking of an identified radar pattern, image, or blob corresponding to a person is lost at any time due to, for example, a crowded room, a dead spot, a stoppage of the person's movements, etc., rendering the pattern, image, or blob unidentified, the identity of the pattern, image, or blob may be reacquired using the biometric data matching technique, a manual entry via a keypad, etc., as noted above. Similarly, biometric data, keypad entries, etc. may also be used to periodically verify or confirm the identity of one or more radar images or blobs to ensure accurate tracking of persons throughout the media environment over time.

Alternatively or additionally, other heuristic data may be used to identify or confirm the identity of a radar blob or image via, for example, habits, patterns of activity, personal schedules, and the like. For example, a person's favorite chair, sleeping patterns, typical movement patterns within their household, etc. may be used to identify or reacquire the identity of a blob, image, or pattern. Such heuristic analyses may be performed, for example, using post processing of collected tracking or audience measurement data to correct or fill raw data gaps (e.g., to associate an identity with pattern or blob tracking data that could not be identified for a period of time) or to otherwise improve the integrity and/or accuracy of the collected data, thereby increasing a confidence level in the data.

Additionally or alternatively, the identity of a radar blob or image may be acquired, reacquired, confirmed, verified, etc. based on path of movement of the radar image or blob. For instance, if tracking and, thus, identity for a particular radar image or blob is lost when, for example, a person associated with the image or blob stops moving, the identity of that person's radar image or blob may be reacquired when the person begins moving again by determining a logical continuation of their path and/or the location where movement stopped. More specifically, if an unidentified moving radar image or blob appears to be a logical continuation of a path of a previously identified radar image or blob, the identity of the previously identified image or blob may be assigned to the unidentified radar image or blob. For instance, an unidentified radar image or blob may begin moving at a location where a previously identified radar image or blob stopped moving (and, thus, where tracking for that identified image or blob was lost). In that case, the unidentified radar image or blob may be assigned the identity of the previously identified image or blob. However, tracking and, thus, identity for a particular radar image may be lost for reasons different than or in addition to a movement stoppage. For instance, one or more of a blockage, a gap in coverage, range and/or field of view limitations, environmental noise, target ambiguity, excessive target speed (e.g., a person moves too quickly), etc. could result in a loss of tracking and identity.

Using the examples described herein, the identification and tracking of persons within monitored media environments is substantially passive because it does not require a person to periodically identify themselves to metering devices. Instead, a person may be automatically identified or may be required to perform a one-time identification process (e.g., a fingerprint scan) upon entry to a monitored media environment and may thereafter be tracked and, if needed, automatically re-identified as they move throughout the monitored environment. Nor do the monitored individuals have to carry PPM's and/or identifying tags or other monitoring or metering devices. Such substantial passivity virtually eliminates compliance-related issues, Hawthorne effect issues, etc. and, thus, substantially improves the overall accuracy or reliability of the audience measurement data collected.

Further, in contrast to many known systems, the example radar-based systems described herein provide virtually pervasive and continuous tracking and metering of individuals because the penetrating waves or signals employed can penetrate walls and/or other objects within a monitored environment to provide substantially continuous coverage of the monitored environment. Additionally, because the radar waves or signals used by the examples described herein can penetrate walls and other objects, the radar devices used can be mounted out of view of the monitored persons (e.g., in, on, and/or behind walls). Still further, the radar-based identification processes used by the examples described herein do not require collection of photo-like images (e.g., video images) of the monitored persons, thereby increasing the likelihood that persons will agree to participate by eliminating concerns that some persons may have about being observed via the collection of such photo-like images.

Thus, in contrast to many known audience measurement systems, the example radar-based audience measurement methods, apparatus, and articles of manufacture described herein can substantially continuously meter the media consumption of persons within, for example, indoor media environments such as buildings, households, etc. Additionally, in contrast to many known systems, the examples described herein are substantially pervasive in their coverage of (e.g., have substantially no dead zones within) the monitored environments and, at the same time, are substantially discreet and non-intrusive. As a result, the examples described herein can provide a monitored environment of invisible omniscience in which the monitored persons do not feel as if they are being observed. Reducing or eliminating the audience's awareness of being observed can substantially reduce the likelihood that the monitoring activity will affect audience media consumption (e.g., the Hawthorne effect) and, thus, increases or improves the accuracy and value of the collected audience measurement data.

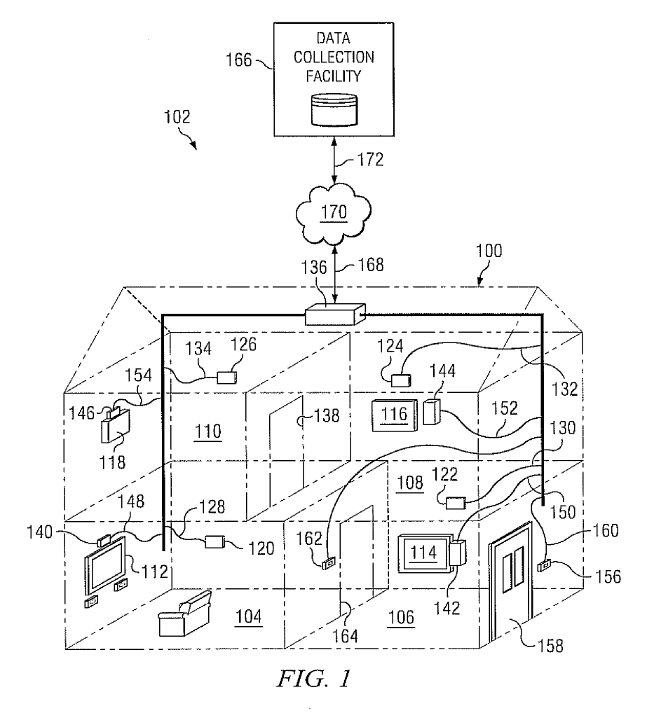

FIG. 1 depicts an example media environment 100 having an example radar-based audience measurement system 102 installed therein. In FIG. 1, the example media environment 100 is depicted as being a home-like building or a household. However, the example radar-based audience measurement systems described herein may be more generally implemented within other media environments such as apartments, condominiums, townhomes, office buildings, retail environments, or any other defined environment or space in which one or more persons may be exposed to media.

The example media environment 100 is composed of or sub-divided into a plurality of media cells 104, 106, 108, and 110, each of which corresponds to an area proximately associated with respective media presentation devices 112, 114, 116, and 118. The media presentation devices 112, 114, 116, and 118 may include one or more televisions, radios, and/or any other equipment capable of rendering audible and/or visual media to a person. In the example of FIG. 1, each of the media cells 104, 106, 108, and 110 corresponds to a respective room or separate space within the environment 100. In other words, each of the separate rooms or spaces within the environment 100 includes only one media presentation device and, thus, only one media cell. However, in other examples, one or more separate spaces or rooms may have no media presentation device, in which case those spaces or rooms may have no media cells, or may have multiple media presentation devices, in which case those spaces or rooms may have multiple media cells.

Additionally, it should be recognized that the boundaries of the media cells 106, 106, 108, and 110 within the example media environment 100 encompass the areas within which a person can effectively consume media presented by the media presentation devices 112, 114, 116, and 118. In this manner, a person's presence within the boundary of a media cell may be used to indicate the person's exposure to and consumption of the media presented therein and to credit consumption of the media. It should be recognized that the boundary of a media cell does not necessarily coincide with the physical boundary of the room or other space in which the media cell is defined. In particular, the boundary or dimensions of a media cell may depend, at least in part, on the type of media presentation device and/or type of media associated with the media cell. For example, in the case where the media presentation device is a television, the boundary of the media cell associated with the television may be determined by the size of the display screen, the viewing angle of the screen, the orientation or location of the television within its room or space and/or relative to seating in the room or space. Thus, depending on these and/or other factors, the media cell associated with a television may have a boundary or dimensions such that the media cell area is smaller, the same as, or larger than the room or space in which the television is located. Typically, however, the media cell dimensions, boundary, or area is smaller than the dimensions, boundary, or area of the room or space in which the television is located. In contrast, in the case where the media presentation device is a radio and/or other audio equipment, the boundary, dimensions, or area of the media cell associated with the radio and/or other audio equipment typically matches the boundary, dimensions, or area of the space or room in which the radio or other audio equipment is located. Further, in some examples, media presentation devices may be sufficiently close or proximate (e.g., proximate in the same room or space or between different rooms or spaces) so that the media cells associated with the media presentation devices overlap.

Returning to the example of FIG. 1, the media cells 104, 106, 108, and 110 include respective radar devices 120, 122, 124, and 126 to detect the locations of persons within the media cells 104, 106, 108, and 110. The radar devices 120, 122, 124, and 126 may be implemented using ultra wideband (UWB) radar devices, backscatter X-ray devices, through wall surveillance (TWS) devices, millimeter wave (MMW) devices (e.g., microwave devices), see through wall radar devices, ground penetrating radar devices, etc. Such devices are generally well known and, thus, are not described further herein. Regardless of the particular type of technology used, which may involve any combination of radar transmitters, receivers, and/or transceivers, to implement the radar devices 120, 122, 124, and 126, the radar devices 120, 122, 124, and 126 are preferably, but not necessarily, installed or mounted in a manner that obscures or hides the radar devices 120, 122, 124, and 126 from persons within the media environment 100. For example, because the radar devices 120, 122, 124, and 126 use signals that can penetrate typical walls and other objects or structures within, for example, a household, the devices 120, 122, 124, and 126 can be mounted inside of walls, behind walls, outside the building or other structure containing the monitored media environment, in or above ceilings, behind or in wall plates (e.g., plates mounted to electrical outlet or switch boxes), or in any other unobtrusive location.

While the example of FIG. 1 depicts a single radar device (e.g., a radar transceiver) for each of the rooms/spaces and media cells 104, 106, 108, and 110, multiple radar devices (e.g., multiple transceivers, one transmitter and multiple receivers, multiple transmitters and receivers, etc.) may be used in one or more rooms/spaces and/or media cells. Alternatively or additionally, one or more radar devices may be used to monitor multiple rooms/spaces and/or media cells. For instance, in one example, a single UWB radar transceiver (e.g., a radar vision device) may be used to monitor all of the media cells 104, 106, 108, and 110 within the media environment 100.

Each of the radar devices 120, 122, 124, and 126 is coupled via a respective one of communication links 128, 130, 132, and 134 to a data collection and processing unit 136. The links 128, 130, 132, and 134 may be implemented using wireless connections (e.g., short-range radio frequency signals such as 801.11 compliant signals), hardwired connections (e.g., separate wires, modulated electrical power lines, etc.), or any combination thereof. The radar devices 120, 122, 124, and 126 may communicate radar image information to the data collection and processing unit 136 using any desired signaling scheme and/or protocol. For example, the radar image information may be communicated using digital information, analog information, or any combination thereof. The links 128, 130, 132, and 134 are one way to enable synchronization of the data collection and processing unit 136 with its nodes (e.g., the radar devices 120, 122, 124, and 126).

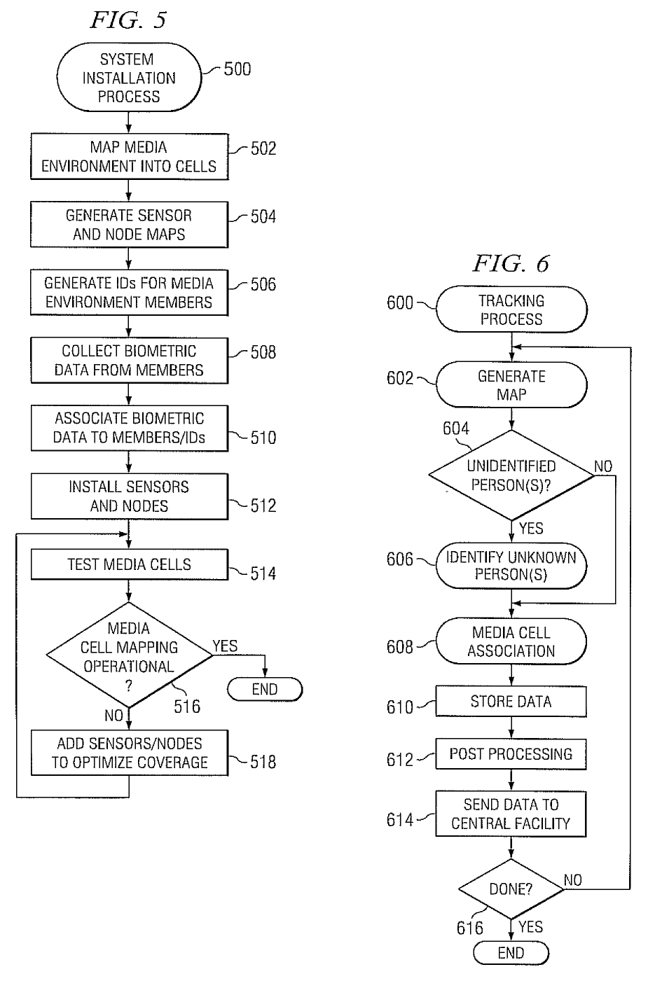

The data collection and processing unit 136 collects and processes the radar information or image data provided by the devices 120, 122, 124, and 126 to track the locations of persons within the media environment 100. More specifically, the data collection and processing unit 136 is configured to perform the methods or processes described in connection with FIGS. 5-11. Thus, as described in greater detail below, the data collection and processing unit 136 can substantially continuously track the locations of persons within the media environment 100 to determine if those persons are currently in one or more of the media cells 104, 106, 108, and 110. The data collection and processing unit 136 may determine that a person is located in more than one media cell at a given time if the person is located in overlapping regions of two or more media cells. For instance, if the boundaries of the media cells 108 and 110 are coincident with the rooms in which the media presentation devices 116 and 118 are located (e.g., the devices 116 and 118 may both be radios) and if a person is located in or near to a doorway 138, that person may be in both of the media cells 108 and 110 at the same time. To resolve such an ambiguity, the data collection and processing unit 136 may associate the person's location with the one of the media cells containing the media presentation device that is actively presenting media (assuming the other is not active) or, if all cells in which a person is located are active, the media cell containing the media presentation device to which the person is nearest.

To determine the status of each of the media cells 104, 106, 108, and 110, the media presentation devices 112, 114, 116, and 118 are coupled to respective status monitors 140, 142, 144, and 146, which are coupled to the data collection and processing unit 136 via respective links 148, 150, 152, and 154. The status monitors 140, 142, 144, and 146 monitor the media presentation devices 112, 114, 116, and 118 to determine if the media presentation devices 112, 114, 116, and 118 are active (e.g., on and presenting media) or inactive (e.g., off and not presenting media). Additionally, the status monitors 140, 142, 144, and 146 may be configured to monitor, for example, the station to which its respective one of the media presentation devices 112, 114, 116, and 118 is tuned, extract codes embedded in the media (e.g., embedded in the audio and/or video signals) being presented, and/or collect signatures (e.g., video and/or audio signatures) associated with the media being presented, etc. In this manner, the tracked location information generated by the data collection and processing unit 136 for each person in the media environment 100 can include information indicating the media cell(s) in which the person is located over time, whether the media cell(s) in which the person is located are active, and/or information (e.g., codes, signatures, station numbers) to identify the media content (e.g., program) being presented. If the data collection and processing unit 136 determines that a person is in an active media cell, the person may be considered exposed to the media program being presented in that active media cell (i.e., a media exposure may be identified), and the program or other media may be credited as viewed, listened to, etc. As with the links 128, 130, 132, and 134, the communication links 148, 150, 152, and 154 may be implemented using wireless connections, hardwired connections, or any combination thereof. Alternatively or additionally, some or all of the links 128, 130, 132, 134, 148, 150, 152, and 154 may be implemented using a local area network or the like to facilitate coupling the media presentation devices 112, 114, 116, and 118, the radar devices 120, 122, 124, and 126, and/or the status monitors 140, 142, 144, and 146 to the data collection and processing unit 136.

To identify persons entering or leaving the media environment 100, a biometric input device 156 is located near an entrance 158 and is coupled to the data collection and processing unit 136 via a link 160. As with the other links discussed above, the link 160 can be implemented using a wireless link, a hardwired link, or any combination thereof. The biometric input device 156 may be configured to identify a person using a fingerprint scan, a retinal scan, gait information, height/weight information, voice information, or any other biological, physiological, or physical characteristics that are sufficiently unique or characteristic of a person to provide a substantially accurate identification of that person. Thus, as described in greater detail below, immediately prior to or upon entering the media environment 100 a person may be identified by comparing the biometric or other information obtained via the biometric input device 156 to a biometric profile stored in the data collection and processing unit 136. Each biometric profile stored in the data collection and processing unit 136 is uniquely associated with an identity of a person previously entered into the data collection and processing unit 136 as a member of the media environment 100 (e.g., a household member) or a visitor to the media environment 100. Each biometric profile is also associated with an identification number, code, or tag which, upon identification of the person at the entrance 158, is associated with the radar image or blob representative of that person's location, as well as the location data and active media exposure or consumption data collected by the data collection and processing unit 136 as the person moves throughout the media environment 100. In this manner, a person can be identified once upon entry to the media environment 100, with little required interaction with the audience monitoring system 102, and that person's radar image, pattern, or blob can then be substantially continuously tracked and monitored as the person moves into and/or out of the media cells 104, 106, 108, and 110. While the example in FIG. 1 uses the biometric device 156 to identify persons entering the media environment 100, other types of identification devices could be used instead. For example, a keypad, card reader, etc. enabling entry of a code, name, or other identifier could be used by a person entering the media environment 100 to provide their identity to the processing unit 136.

Typically, once a person's radar image or blob has been identified by the audience measurement system 102, the audience measurement system 102 can track the location of the person as they move throughout the media environment 100. However, if the audience measurement system 102 loses a tracking lock on a person (i.e., cannot identify a radar image or blob associated with an occupant of the media environment 100), a tracking lock can be re-established by reacquiring the identity of the radar image or blob using, for example, physiological, biological, and/or other physical characteristics substantially uniquely indicative of the person. For instance, as described in greater detail below, an unidentified radar image, pattern, or blob associated with a person may be identified by detecting the heart rate, breathing pattern, pattern of movement, etc. via a detailed analysis of the radar image, pattern, or blob. More specifically, the data collection and processing unit 136 may collect the characteristics of the radar image, pattern, or blob representative of heart rate, breathing pattern, pattern of movement, etc. and compare these collected characteristics to stored information (e.g., biometric profile information or other profile information) associated with persons previously monitored by or otherwise known to the system 102. If the data collection and processing unit 136 identifies a matching profile, the identity of the person associated with that profile may be assigned to the unidentified radar image or blob.

Alternatively or additionally, a tracking lock may be reacquired for an unidentified radar image or blob associated with a person via one or more additional biometric devices (e.g., similar to the biometric input device 156), keypad input devices, and/or card reader input devices mounted in certain locations in the media environment 100. For example, a biometric, keypad, or other type of input device 162 may be mounted near to an internal doorway 164 (or a dead zone) to enable a person passing from one space to another (e.g., from one room to another) to identify themselves to the system 102. More generally, such additional input devices may be mounted in locations where overlapping or continuous monitoring coverage (e.g., continuous radar mapping) is difficult or impossible due to the layout of the media environment and/or other structural conditions within the media environment 100.

As depicted in the example of FIG. 1, the data collection and processing unit 136 is coupled to a data collection facility 166 via link 168, network 170, and/or link 172. The links 168 and 172 may be any desired wireless or hardwired links such as, for example, telephone lines, cellular links, satellite links, etc. The data collection and processing unit 136 may periodically convey tracking data including the identity and location information and, particularly, the media cells within which persons within the media environment 100 were located, the status (e.g., active/inactive) of the media cells at the time(s) the persons are in the media cells, and media program identifying information (e.g., codes, signatures, etc.). The data collection facility 166 may receive audience measurement information from a plurality of other media environments and may aggregate the received information to generate statistically significant audience measurement data for a population of people within a particular geographic region, people having particular demographic characteristics, people living in a particular type or types of households, etc.

Prior to sending collected data to the data collection facility 166, the data collection and processing unit 136 may perform post processing operations to improve the accuracy or quality of the data. For example, as described in greater detail below, the data collection and processing unit 136 may collect and maintain heuristic information relating to the persons that live in (e.g., household members) or that visit the media environment 100. Such heuristic information may be representative of certain patterns of activity or movement associated with particular persons. For example, a person's typical schedule (i.e., the times at which they are typically present in certain locations within the media environment 100), a person's favorite chair or other piece of furniture associated with consumption of media within the media environment 100, the manner in which the person moves (e.g., speed, gait, etc.) within the media environment 100, the person's typical sleeping locations, etc. may be determined by the data collection and processing unit 136 over time and stored in connection with that person's identity in the data collection and processing unit 136. In other words, over time, the data collection and processing unit 136 may learn the patterns of behavior associated with each of the persons to be monitored by the audience measurement system 102 and may use such learned patterns of behavior to improve the collected tracking data. In particular, if the tracking data collected by the data collection and processing unit 136 includes location information associated with unidentified radar images or blobs, such tracking data may be corrected by comparing the tracking data to stored heuristically generated profiles for each of the persons tracked by the data collection and processing unit 136. If matching heuristic data is found, the identity of the person associated with that heuristic data is assigned to the unidentified radar image or blob location data. In some examples, the data collected by the data collection and processing unit 136 may be mined for alternative research or statistics.

While the use of heuristic post processing of tracking data is described as being performed by the data collection and processing unit 136, such post processing operations could instead be performed at the data collection facility 166. Further, such post processing activities could alternatively be performed by the data collection and processing unit 136 in substantially real time. In other words, if a previously identified and tracked radar image or blob becomes unidentified, the data collection and processing unit 136 may, in addition to or as an alternative to using biometric, biological, or physiological information, use heuristic pattern matching as described above to identify the unidentified radar image or blob.

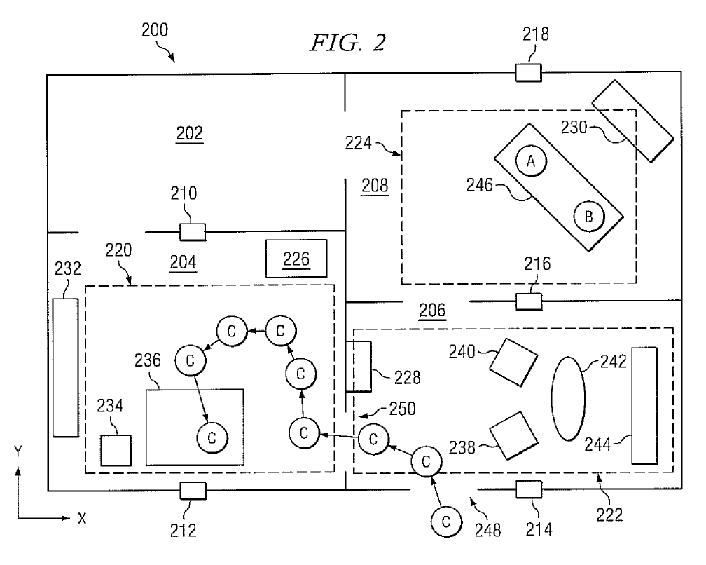

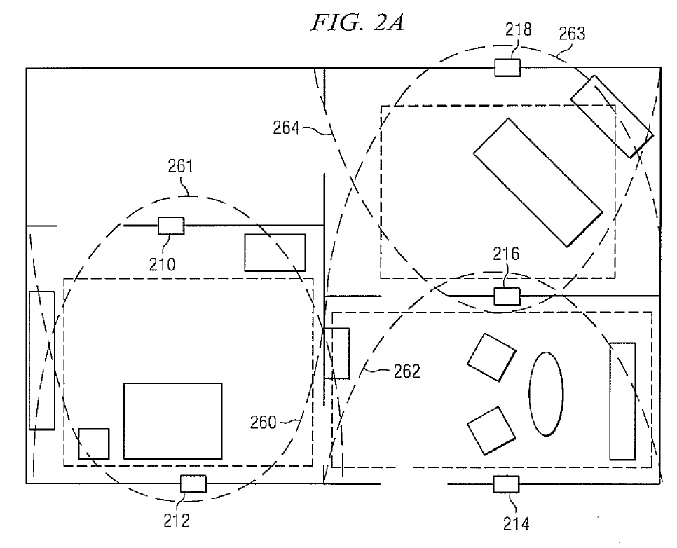

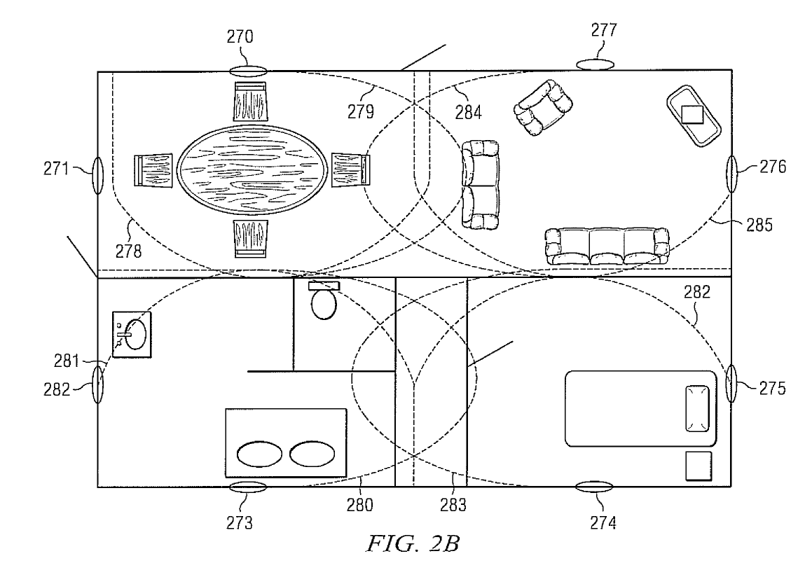

FIG. 2 is an example media environment 200 that may be monitored using the example radar-based system 102 described in connection with FIG. 1. Before providing a detailed description of the example media environment 200, it should be recognized that the radar-based tracking techniques described herein provide person tracking information (e.g., location information) in three dimensions (e.g., x, y, and z directions). However, for purposes of simplifying the discussion, the example media environment 200 is described in connection with a two-dimensional view. Turning in detail to FIG. 2, the example media environment 200, which may be a household or the like, includes four rooms 202, 204, 206, and 208. For purposes of this discussion, the room 202 is a bathroom, the room 204 is a bedroom, the room 206 is a living room, and the room 208 is a family room. However, the rooms 202, 204, 206, and 208 could be any other combination of room types.

The example media environment 200 also includes five radar devices (e.g., any desired combination of radar receivers, transmitters, and/or transceivers) 210, 212, 214, 216, and 218, each of which is preferably, but not necessarily, mounted in an unobtrusive manner (e.g., in a wall plate, within a wall, behind a wall, etc.). Additionally, the radar devices 210, 212, 214, 216, and 218 are located to optimize the radar mapping coverage of the rooms 204, 206, and 208 and, particularly, radar mapping of media cells 220, 222, and 224, which are associated with respective media presentation devices 226, 228, and 230. For the purposes of this example, the media presentation device 226 is a television, the media presentation device 228 is a radio, and the media presentation device 230 is a television. Thus, the media cell 220 has an area that is smaller than the bedroom 204. Similarly, the media cell 224 associated with the television 230 has an area that is smaller than that of the family room 208. In contrast, because the media presentation device 228 is a radio, the media cell 222 has an area that is substantially equal to that of the living room 206.

Each of the rooms 204, 206, and 208 includes certain fixed objects such as the media presentation devices 226, 228, and 230 and furniture 232, 234, 236, 238, 240, 242, 244, and 246. Additionally, three persons are depicted as occupying the media environment 200. These persons are represented as the encircled letters “A,” “B,” and “C.” As depicted, persons A and B are seated on the furniture 246 (e.g., a couch) proximate to the television 230. Person C is depicted as moving through an entrance 248, passing through the living room 206 and into the bedroom 204 via a doorway 250, stopping in front of the television 226 (e.g., to turn it on), and then over to the furniture 236 (e.g., a bed).

In operation, the radar devices 210, 212, 214, 216, and 218, at some periodic or virtually continuously rate, collect radar data for the rooms 204, 206, and 208. In practice, the coverage provided by the devices 210, 212, 214, 216, and 218 may be overlapping and may also provide coverage within rooms/spaces for which there is no media cell (e.g., the bathroom 202). However, such overlapping and/or coverage in spaces for which there is no corresponding media cell may be ignored for purposes of crediting media exposure and the like. Nevertheless, such coverage may be useful to supply substantially continuous location or tracking information for the persons occupying the media space 200. In other words, minimizing or eliminating dead space(s) or zones (i.e., spaces or areas in which persons cannot be effectively tracked) within the media environment 200 minimizes or substantially eliminates the likelihood of losing tracking of a person (e.g., their radar image, pattern, or blob becoming unidentified) once they have entered the media environment 200.

The radar data or information collected by the devices 210, 212, 214, 216, and 218 is analyzed and processed (e.g., by the data collection and processing unit 136) to generate radar maps of the media environment 200. As described in greater detail below, the radar maps are then further processed to determine the locations of radar images or blobs that are not considered background or fixed objects (e.g., furniture, media presentation devices, etc.). The locations of the radar images or blobs that are not considered background or fixed objects may be persons occupying the media environment 200. The locations of the radar images or blobs potentially corresponding to persons occupying the media environment 200 may be the x, y, and z coordinates of the radar images or blobs referenced to an origin defined at system installation. For example, because such radar images or blobs may extend in three dimensions, the locations of the radar images or blobs may be defined to be the coordinates of the centroids of the images or blobs. However, the location may alternatively be defined using any other geometric construct or in any other desired manner.

The radar images or blobs potentially corresponding to persons occupying the media environment 200 are then analyzed to identify the persons, if any, corresponding to the images or blobs. In one example, a radar map including only images or blobs potentially corresponding to persons occupying the media environment 200 may be compared to a previously generated radar map including only images or blobs potentially corresponding to persons occupying the media environment 200. In many cases, such a comparison will enable a previously identified (i.e., previously associated with a particular person) image or blob to be tracked as it moves, thereby enabling radar images or blobs to be identified (i.e., associated with particular persons) as a result of their proximate relationship to the location of an identified image or blob in a previously generated radar map. While such location-based tracking and identification of radar images or blobs is very effective, in some cases, such as, for example, crowded rooms, dead zones, etc., such location-based tracking and identification may be difficult because the radar images or blobs corresponding to persons occupying the media environment 200 may overlap, merge, or otherwise become indistinguishable.

To overcome the difficulties that can occur when using the above-described location-based tracking and identification technique, radar images or blobs potentially corresponding to persons occupying the media environment 200 that cannot be identified based on a preceding or previous radar map or maps may alternatively be identified by matching the biological, physiological, and/or other physical characteristics evidenced by the unidentified images or blobs to profiles of known persons stored in a database (e.g., in a database maintained by the data collection and processing unit 136 and/or the data collection facility 166). For example, as noted above, the radar images or blobs may be analyzed to determine a heart rate, a breathing pattern or rate, for radar cross-section, gait, height, etc. and one or more such characteristics may be sufficiently unique to identify a particular person.

FIG. 2A depicts example coverage zones for the example media environment 200 of FIG. 2. In particular, as depicted in FIG. 2A, the radar devices 210, 212, 214, 216, and 218 provide respective overlapping coverage zones 260, 261, 262, 263, and 264. The shapes of the zones 260-264 are merely representative and, thus, may have somewhat different shapes in practice. However, in general, the zones 260-264 may have the shapes depicted in FIG. 2A when, for example, the radar devices 210, 212, 214, 216, and 218 are monostatic synthetic aperture radar devices or transceivers.

FIGS. 2B and 2C depict other example coverage patterns that may be used to implement the example radar-based audience measurement systems described herein. In particular, the example media environment depicted in FIG. 2B includes radar transceivers 270-277 providing respective overlapping coverage patterns 278-284. As with the example of FIG. 2A, the coverage patterns depicted in FIG. 2B are merely representative of the types of patterns that may be provided when monostatic synthetic aperture radar devices are used to implement the transceivers 270-277. In FIG. 2C, radar receivers 286-293 cooperate with radar transmitter 294 to provide respective elliptically-shaped coverage patterns extending between the receivers 286-293 and the transmitter 294. Alternatively or additionally, if the radar device 294 is a transceiver, then a series of overlapping generally circular coverage patterns may be provided as shown. The elliptical coverage patterns may be referred to as bi-static coverage patterns. A variety of other coverage patterns may be provided based on the type of radar devices used, the arrangement of the devices, the characteristics of the space being monitored, etc.

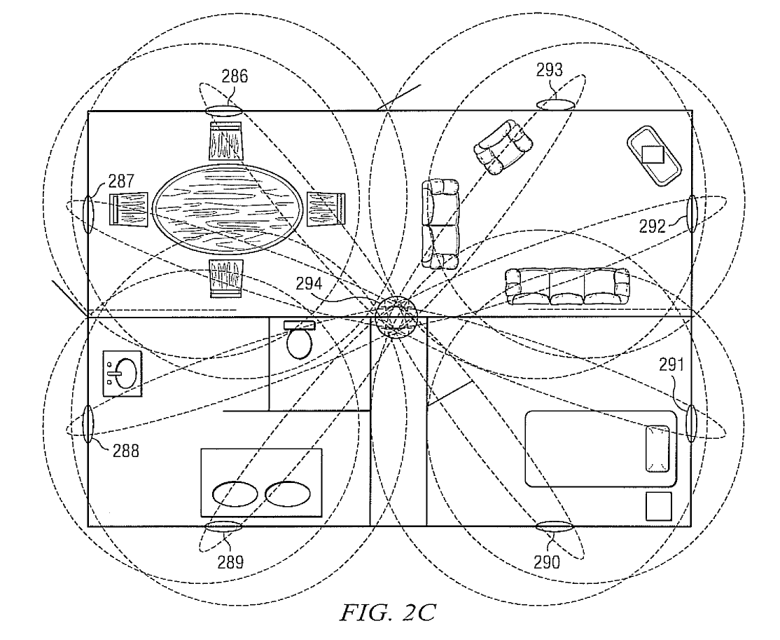

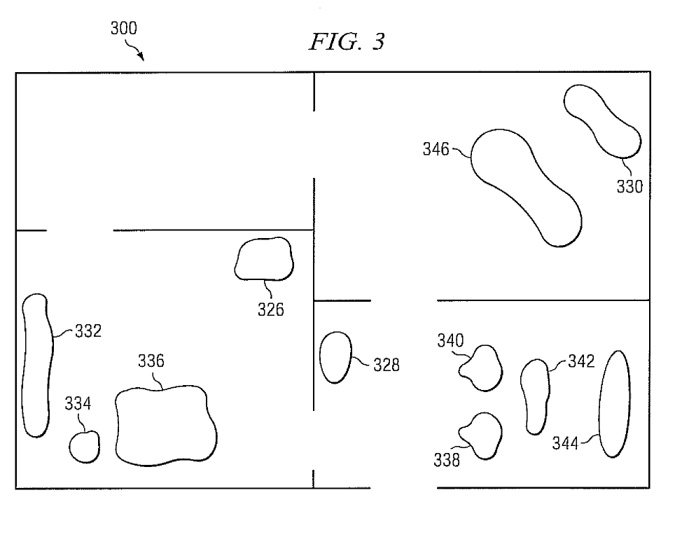

FIG. 3 depicts an example radar map 300 of the example media environment 200 of FIG. 2 in an unoccupied condition. As shown, the example map 300 includes a plurality of images or blobs 326, 328, 330, 332, 334, 336, 338, 340, 342, 344, and 346, which correspond respectively to the media presentation devices 226, 228, and 230, and the furniture 232, 234, 236, 238, 240, 242, 244, and 246. The images or blobs 326-346 are merely provided to illustrate that the radar images corresponding to the media presentation devices 226-230 and the furniture 232-246 may be only roughly shaped like the physical objects that they represent. However, depending on the type of technology used to implement the devices 210, 212, 214, 216, and 218, the images or blobs 326-346 may be more or less similarly shaped like the objects that they represent.

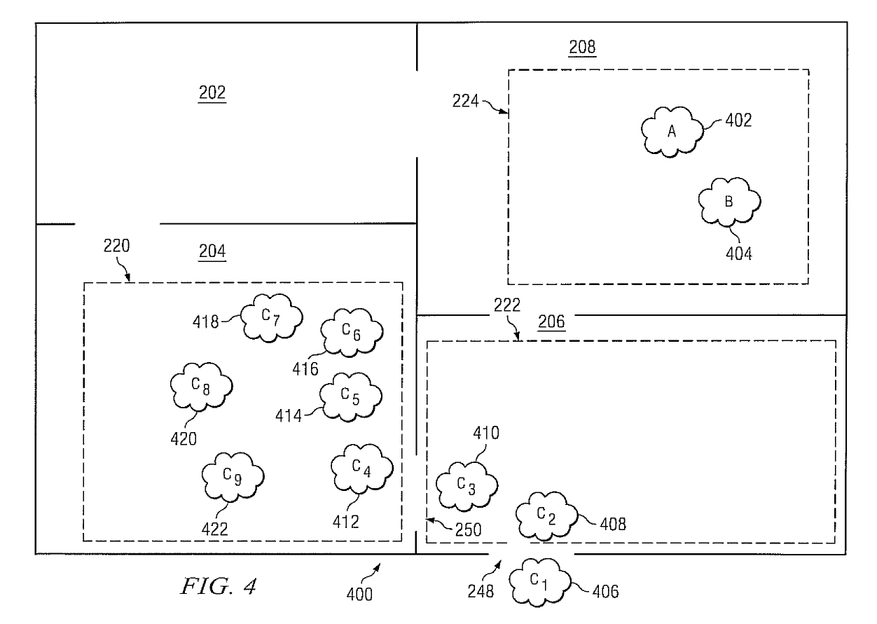

FIG. 4 depicts an example of a series of overlaid radar maps 400 of the occupied media environment 200 of FIG. 2 from which the example map 300 of FIG. 3 has been subtracted to leave radar images or blobs representing the locations of the occupants or persons A, B, and C. Thus, the example maps 400, which depict a plurality of overlaid time-sequenced maps, do not include any radar images or blobs corresponding to fixed objects such as the media presentation devices 226, 228, and 230 or the furniture 232-246. Instead, only the non-fixed objects corresponding to persons A, B, and C remain in the maps 400, which may be referred to as difference maps or occupant maps.

As can be seen in FIG. 4, persons A and B correspond to images or blobs 402 and 404, which remained substantially stationary for the time during which the maps 400 were generated. Thus, if the media cell 224 were active during the time when the maps 400 were generated, it could be concluded that persons A and B were consuming the media being presented via the family room television 230.

In contrast, person C appears to have been moving during the generation of the maps 400 and, thus, causes the generation of a series of images or blobs 406-422 within the maps 400. In one example, the image or blob 406 may initially be identified as person C at the entrance 248. For example, an input device (e.g., the input device 156 of FIG. 1) may be used to identify person C. Subsequently, the image or blob 408 appears within the media cell 222 and is considered to be person C due to its proximity and/or the similarity of its characteristics to the image or blob 406. If the media cell 222 is active (e.g., if the radio 228 of FIG. 2 is presenting a radio program), exposure credit may be given to the media being presented in the cell 222. However, in some cases, credit to the media program being presented in the media cell 222 may not be given if it is determined that person C is moving too quickly through the media cell 222 to have been effectively consuming the media program. In a subsequent map, person C appears as the image or blob 410 and, thus, is still within the media cell 222. Again, any media program being presented in the media cell 222 may or may not be given credit depending on the crediting rules in effect. Person C is further tracked as the images or blobs 412-422 in a series of subsequent radar maps. The images or blobs 412-422 are located within the media cell 220. Thus, if the media cell 220 is active (e.g., if the bedroom television 226 is on and presenting media), Person C may be identified as exposed to the media being presented and the media being presented may be credited with consumption if the movement (or lack thereof) of the images or blobs 412-422 and the crediting rules in effect indicate that credit should be given.

As discussed above in connection with FIG. 1, if a tracking lock is lost for person C as they move within the media environment 200 and one or more of the radar images or blobs corresponding to person C are unidentifiable using a location-based identification scheme, biological, physiological, and/or other physical characteristic data may be determined based on the characteristics of the blobs themselves. For example, the radar devices 210-218 may provide data that enables a heart rate, a breathing rate, a breathing pattern, etc. to be determined from the unidentified images or blobs. Such physical characteristic data may then be compared to physical characteristic profile data associated with known persons. If matching profile data is found, the identity of the person corresponding to the profile data is assigned to the unidentified image(s) or blob(s). For instance, the image or blob 410 may be identified as person C, but the subsequently acquired image or blob 412 may initially be unidentified because tracking lock was lost as person C moved from the living room 206 and the media cell 222 through doorway 250 and into the bedroom 204 and the media cell 220. In that case, the characteristics of the image or blob 412 may be analyzed to identify the person (i.e., person C) associated with the image or blob 412 by matching physical characteristic data as described above.

Before discussing the flow diagrams provided in FIGS. 5-11, it should be recognized that the operations set forth in these flow diagrams may be implemented using machine readable instructions, firmware, software, code, or logic that is executable by a processor. Alternatively or additionally, some or all of the operations may be implemented using one or more hardware devices such as application specific integrated circuits (ASIC's), programmable gate arrays, discrete logic, etc. Still further, one or more of the operations represented in the flow diagrams may be performed manually and/or may be performed using any combination of hardware, software, firmware, and/or manual operations. Additionally, one or more of the operations depicted in the flow diagrams may be performed in a different order than shown and/or may be eliminated.

FIG. 5 is a flow diagram depicting an example process 500 that may be used to install the example radar-based audience measurement systems described herein. The system installation process 500 is typically performed once during installation of the radar-based audience measurement systems described herein. However, if desired, one or more of the operations depicted in FIG. 5 may be performed one or more additional times following the installation of a radar-based audience measurement system. Beginning at block 502, the example process 500 maps the media environment to be monitored into one or more media cells. Such media cells are representative of the areas surrounding the media presentation devices within which it is reasonably certain or likely that a person is consuming any media being presented by the media presentation devices associated with those cells. The mapping operation(s) performed at block 502 may be performed manually by, for example, illustrating the media cell boundaries on a scale floor plan of the media environment to be monitored. Additionally, an origin (i.e., an x=0, y=0, and z=0 point) is selected or defined for the monitored media environment. The locations and boundaries of the media cells can then be defined relative to the selected origin.

After mapping the media environment into one or more cells (block 502), biometric sensor and radar device node maps may be generated (block 504). The sensor and node maps depict the mounting positions of the biometric devices and radar devices within the media environment to be monitored. Again, the sensor and node maps may depict the desired locations for radar devices (e.g., the radar devices 120, 122, 124, and 126 of FIG. 1) as well as the coverage provided by the devices (e.g., the field of coverage). Preferably, but not necessarily, the radar devices may be located to provide overlapping coverage so that substantially complete coverage of the spaces, and particularly the media cells, within the monitored media environment is achieved. The information generated at block 504 may be manually generated and, if desired, illustrated on a floor plan of the media environment to be monitored. The locations of the sensors and nodes may be defined relative to the origin as selected at block 502.

For each member of the media environment to be monitored an identifier (ID) is generated (block 506). For example, a serial number, a text identifier, and/or an alphanumeric string may be generated and uniquely associated with each member of the media environment to be monitored. Preferably, but not necessarily, each member is a member of a household (e.g., a person that lives in or that otherwise occupies the media environment to be monitored) or, more generally, a member of the media environment. However, ID's for persons visiting the media environment (i.e., visitors) may also be generated, if desired.

Biometric data is then collected from each of the members to be monitored (block 508) and associated with the members' ID's (block 510). The biometric data collected at block 508 may include fingerprint information, retinal information, voice print information, and/or any other biological, physiological, and/or physical characteristic data that can be used to substantially uniquely characterize a person. The information collected at block 508 for each person may be generally referred to as a biometric profile or a profile for that person. The biometric data may be collected at block 508 using, for example, portable biometric devices that can be taken to and used to collect biometric data from the persons for whom profiles are needed. The profile information for each person may be locally stored (e.g., at the data collection and processing unit 136 of FIG. 1) and/or remotely stored (e.g., at the data collection facility 166). As described in greater detail below, the profile information developed at block 508 may be accessed and compared to biometric information collected from an unidentified person to enable identification of that person.

The sensors and nodes (e.g., the biometric and/or other input devices and the radar devices) are then installed in accordance with the maps generated at block 504 (block 512). After installing the sensors and nodes (e.g., the biometric sensors or other input devices and the radar devices) at block 512, the media cells are tested (block 514). If the media cell mapping is not found to be operational (block 516), additional sensors and/or nodes are added or moved to improve or optimize coverage (block 518) and the media cells are tested again (block 514). When the media cell mapping is found to be operational at block 516, the installation process 500 is complete.

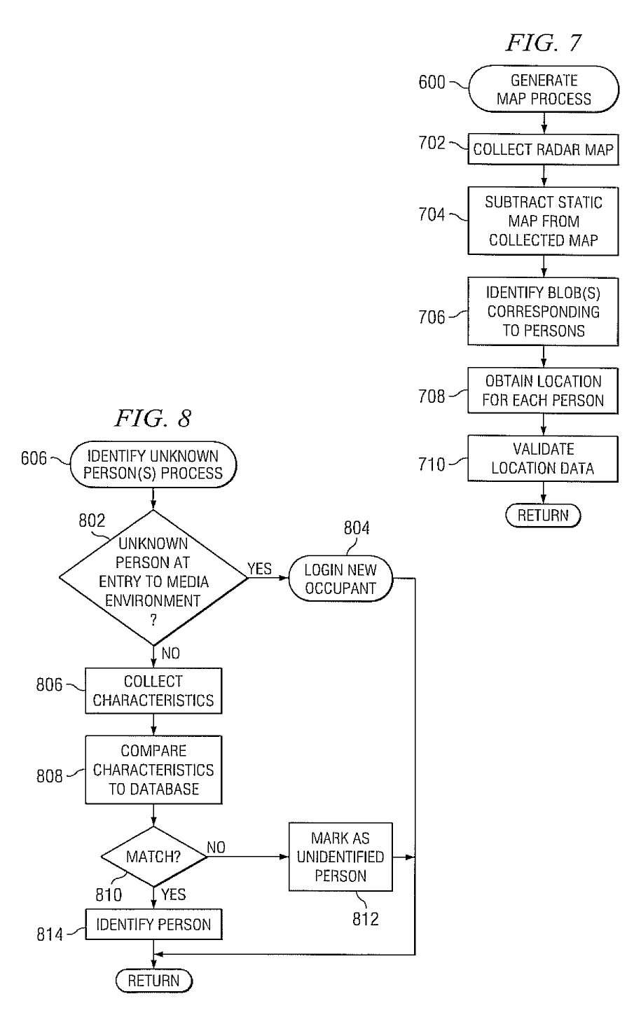

FIG. 6 is a flow diagram depicting an example process 600 that may be used in the example radar-based audience measurement systems described herein to track audience members. The example tracking process 600 generates a radar map (block 602) using, for example, information or data collected via a plurality of radar devices (e.g., the devices 120, 122, 124, and 126 of FIG. 1). An example radar map 400 is shown in FIG. 4 and a more detailed example map generation process is described in connection with FIG. 7 below.

The radar map generated at block 602 is analyzed to determine if there are any unidentified persons occupying the media environment being monitored (block 604). More specifically, the map may contain one or more radar images or blobs representative of persons that are not identified. Such unidentified images or blobs may correspond to persons that were previously being tracked, but for which a tracking lock was lost due to a crowded room, children playing, people entering/exiting dead zones, etc. Alternatively or additionally, one or more unidentified images or blobs may correspond to one or more persons at or approaching an entrance to a media environment to be monitored.

In any case, if the process 600 determines at block 604 that one or more radar images or blobs correspond to one or more unidentified persons, an unknown persons identification process 606 is performed. The unknown persons identification process 606 may perform a login process for any new occupants or may collect biometric characteristics, biological characteristics, and/or physiological characteristics (e.g., heart rate, breathing pattern or rate, etc.) to identify persons via a biometric profile or other physical characteristics profile matching process. A more detailed example of a process for identifying unknown persons is described in connection with FIG. 8 below.

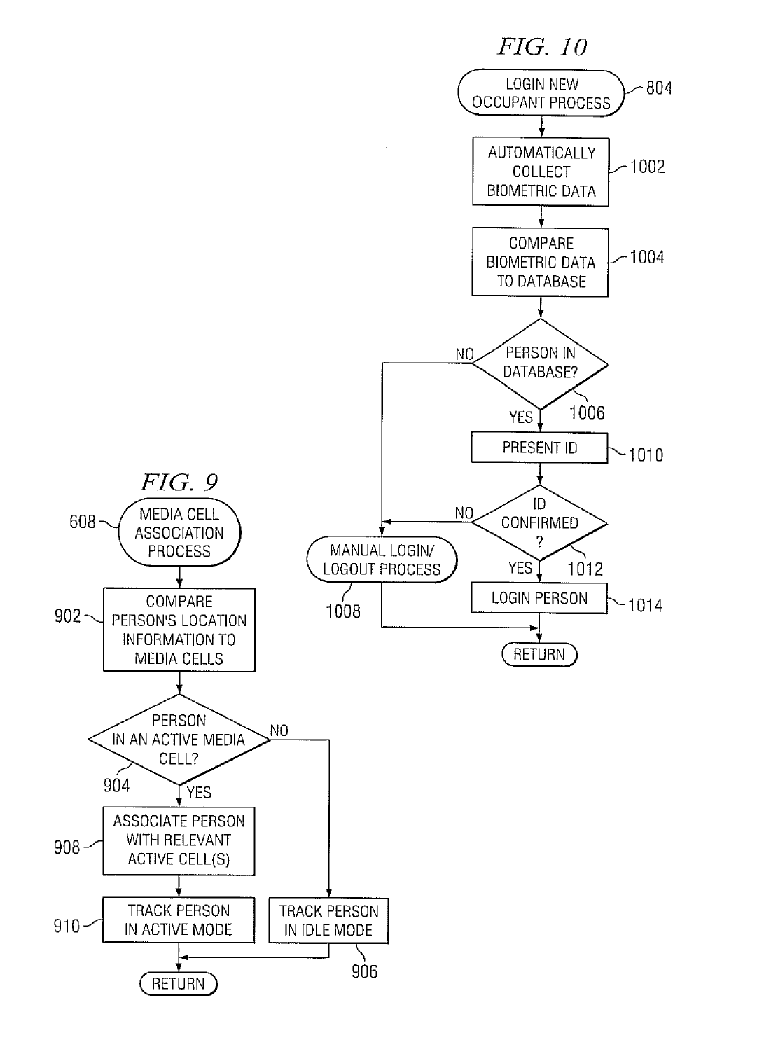

If there are no unidentified persons at block 604 or after performing the unknown person(s) identification process at block 606, the tracking process 600 performs a media cell association process (block 608). In general, the media cell association process (block 608) uses the location information for each identified person to determine whether that person is in a media cell and whether the media cell is active (e.g., whether a media presentation device is presenting a media program). If a person is determined to be in an active media cell, appropriate monitoring data may be associated with that person to identify and exposure of the person to a media program and so that the media program may be credited with consumption by that person. A more detailed example of a media cell association process is described in connection with FIG. 9.

Following the media cell association process (block 608), the tracking process 600 may store the tracking data (e.g., location data for each person, data identifying media consumption activities for each person, etc.) (block 610). The tracking data may be post processed (block 612) to improve the quality or accuracy of the data. For example, heuristic profile information for each tracked person may be used to bridge gaps in location data and/or to identify radar images or blobs that were not identifiable following the unknown person identification process (block 606). Such heuristic profile information may include personal schedule information, patterns of activity, favorite locations (e.g., a favorite chair), sleeping patterns, etc.

The tracking data may be communicated to a central facility (block 614) at which audience measurement data collected from a plurality of monitored media environments may be aggregated and statistically analyzed to generate audience measurement data reflecting the consumption behaviors of persons in a particular geographic region, persons associated with a particular demographic profile, persons living in a particular type of household, etc. If the tracking process 600 is to be continued (block 616), the process 600 returns control to block 602.

FIG. 7 is a flow diagram depicting in more detail the example map generation process 600 of FIG. 6. Initially, the example map generation process 600 collects a radar map (block 702) and then subtracts a static radar map from the collected map (block 704). The static radar map subtracted at block 704 is a radar map including only the fixed objects (e.g., furniture, media presentation devices) in the media environment being monitored (e.g., the map 300 of FIG. 3). The result of the subtraction at block 704 is a radar map including only non-fixed objects or persons (e.g., represented as radar images or blobs) such as the example map 400 of FIG. 4. The static radar map and/or other radar information subtracted at block 704 may also include any tagged pets, persons, etc. that are not being monitored, moving objects such as, for example, doors, fans, curtains, etc., predetermined areas in which movement is to be ignored (e.g., a pet cage, a crib, etc.), or any other information relating to persons, animals, or objects that are not likely consuming media and/or which are not to be monitored. The process 600 then identifies radar images or blobs corresponding to persons (block 706) and obtains location information for each of those persons (block 708). The location information obtained at block 708 may be the x, y, and z coordinates relative to an origin determined during the installation process of FIG. 5. The location information may then be validated (block 710) by, for example, determining if the location data corresponds to an actual location within the media environment being monitored or if such a change in position is physically possible or reasonable.

FIG. 8 is a flow diagram depicting in more detail the example process 606 for identifying unknown persons of FIG. 6. Initially, the process 606 determines if there is an unknown person at an entry to the media environment (block 802). One or more radar devices may be used to detect a person at an entry to a media environment. For example, referring to FIG. 2, the radar device 214 could be used to detect the Person C at the entry 248. If a person is detected at an entry (block 802), the process performs a login new occupant process (block 804). In general, the login new occupant process (block 804) may use biometric information obtained from the person at the entry to identify the person and to provide an ID for use in tagging the location data collected during subsequent tracking operations. A more detailed description of the login new occupant process 804 is provided below in connection with FIG. 10.

If an unknown person is not present at the entry to the media environment (e.g., the unknown person is already located somewhere within the media environment) at block 802, the process 606 collects characteristics of the unknown person (block 806). The characteristics collected at block 806 may be biological, physiological, and/or other physical characteristics. For example, the heart rate, breathing rate, breathing pattern, gait, movement pattern, etc. associated with the unknown person may be collected. One or more of the collected characteristics may then be compared to characteristic profiles stored in a database (block 808). If a match cannot be found in the database at block 810, the person (e.g., the radar image or blob) is marked as unidentified (block 812). On the other hand, if a match is found at block 810, then the ID associated with the matching profile or characteristics is assigned to the radar image or blob representative of the unknown person (block 814).

FIG. 9 is a flow diagram depicting in more detail the example process 608 for associating media cells with persons of FIG. 6. The example process 608 initially compares the person's location information (e.g., the x, y, and z coordinates of the person's radar image or blob) to the location(s) of the media cells composing the monitored media environment (block 902). The example process 608 then determines if the person is in an active media cell (block 904). If the process 608 determines that the person is not in an active media cell (block 904), then the process 608 tracks the person in an idle mode (block 906). On the other hand, if the process 608 determines that the person is in an active media cell (block 904), then the process 608 associates the person with the relevant active cell (block 908). More specifically, at block 908, the process 608 associates the person being tracked with the active media cell in which they are located or, if they are in more than one active cell, the cell associated with the media presentation device from which they are most likely consuming media. A number of factors may be used to select a media device from which it is most likely that a person is consuming media. For example, the proximity of the media device (e.g., whether the media device is the nearest media device), the directionality of the media device output, the loudness of any audio output by the media device, whether the person is wearing headphones or the like, etc. Once the person has been associated with the relevant active cell at block 908, the person is tracked in an active mode (block 910).

FIG. 10 is a flow diagram depicting in more detail the example process 804 for logging in a new occupant of FIG. 8. The example login new occupant process 804 automatically collects biometric data from a person (block 1002). For example, as a person approaches an entry of a media environment being monitored, one or more radar devices may obtain biological, physiological, and/or other physical characteristic data associated with that person. More specifically, the one or more radar devices may be used to acquire from the radar image or blob associated with that person a heart rate, breathing rate, breathing pattern, etc. Additionally or alternatively, physical characteristics such as, for example, the height, weight, radar cross-section, gait, etc. associated with the person may be acquired. Regardless of the physical characteristics collected, the physical characteristics used are preferably sufficiently unique to the person to permit a reasonably certain identification of that person.

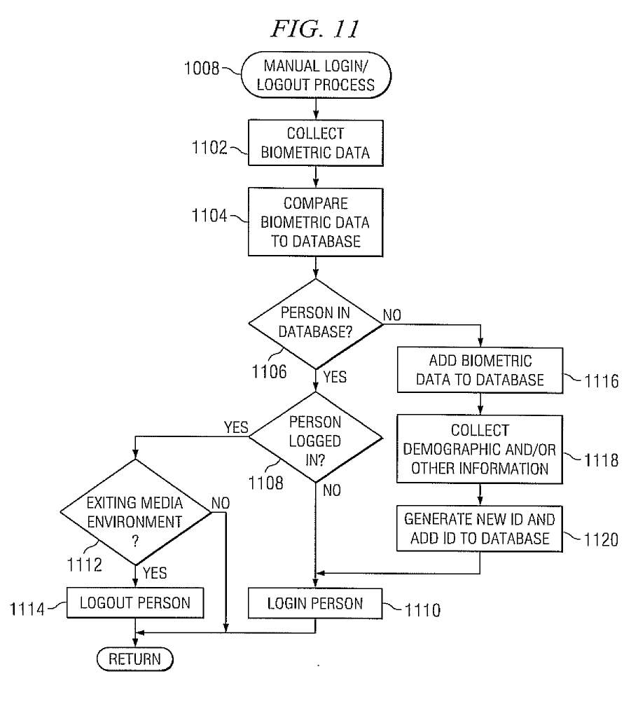

The data collected at block 1002 is then compared to biometric data profiles stored in a database (block 1004). The process 804 then determines if the collected physical characteristics associated with the person (i.e., the new occupant) matches a profile stored in the database (block 1006). If there is no matching profile at block 1006, then a manual login/logout process is performed (block 1008). A more detailed description of the manual login/logout process (block 1008) is provided in connection with FIG. 11 below.

On the other hand, if a matching profile is found in the database at block 1006, then the process 804 may present the identification information associated with the matching profile (block 1010). For example, a person's name and/or other information pertaining to the person associated with the matching profile may be visually displayed, audibly announced, or otherwise presented to the new occupant. The new occupant may then confirm (or reject) the identification information presented (block 1012). If the new occupant rejects the identification information presented, thereby indicating that they are not the person associated with the allegedly matching profile found at block 1006, then the process 804 proceeds to perform the manual login/logout process 1008. On the other hand, if the new occupant accepts the identification information presented at block 1010, then the process 804 logs in the new occupant (e.g., notifies the tracking system that the person is to be tracked throughout the monitored media environment) (block 1014).

FIG. 11 is a flow diagram depicting in more detail the example process 1008 for manually logging in a person of FIG. 10. Initially, the example manual login/logout process 1008 collects biometric data from the person being logged in/out (block 1102). For example, the person may input their fingerprint information, retinal information, and/or voiceprint information, via a biometric input device. The input biometric information is then compared to biometric data (e.g., biometric profiles) in a database (block 1104). If a matching profile is found in the database (block 1106), then the process 1108 determines if the person is logged in (block 1108). If the person is not logged in at block 1108, then the process 1108 logs the person into the tracking system (block 1110). On the other hand, if the person is found to not be logged in at block 1108, then the process 1008 determines if the person is exiting the media environment (block 1112). The process 1008 may also or further determine if the person is exiting the media environment at block 1112 by examining precisely the person's location. For example, if the person is utilizing a biometric input device (e.g., at block 1102) positioned adjacent to an entrance/exit to a home or other household, the process 1008 may assume that the person is exiting the media environment. Alternatively or additionally, the process 1008 may determine whether the person is exiting the media environment based on location data, if any, previously collected for that person. For example, if the previous location data for that person suggests a path indicative of a person leaving or exiting the media environment, then the process 1008 may assume that the person is exiting the media environment. In any case, if the process 1008 determines that the person is exiting the media environment at block 1112, then the person is logged out (block 1114).

If, at block 1106, the process 1008 determines that the person being logged in/out is not in the database, then the process 1008 adds the biometric data collected at block 1102 to the database (block 1116). The process 1008 may also collect demographic and/or other information from the person via, for example, a key pad or other input device (block 1118). The process 1008 then generates an identifier (e.g., a serial number, an alphanumeric text string, etc.) to uniquely identify the person to the tracking system and then adds the new identifier to the database (block 1120). Once the person has been added to the database at block 1120, the process proceeds to block 1110 to login the person.

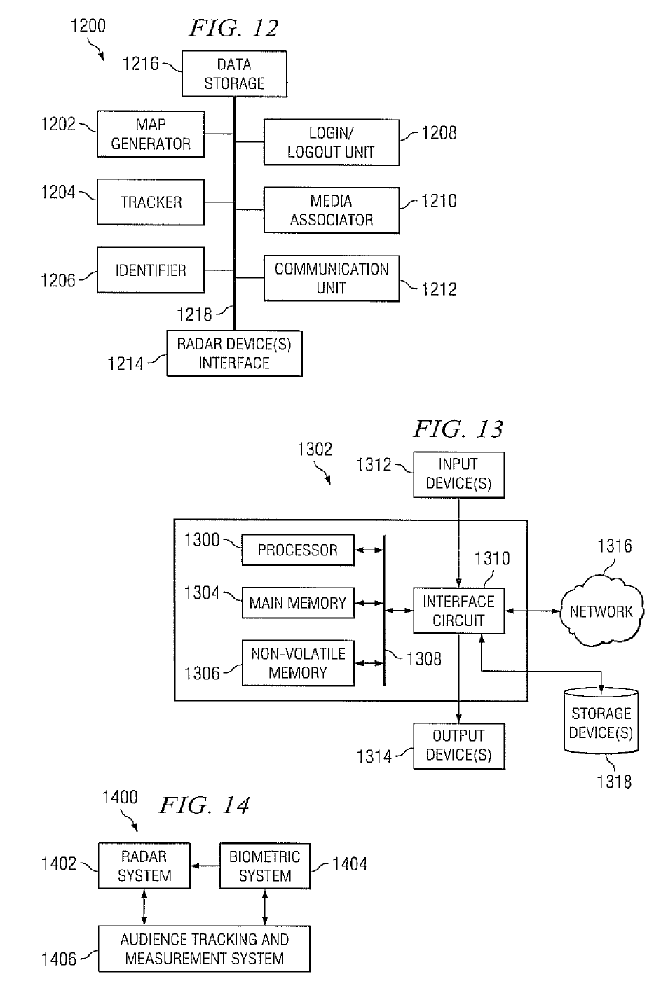

FIG. 12 is a block diagram of an example radar-based system 1200 that may be used to implement the example radar-based audience measurement apparatus and methods described herein. In particular, the radar-based system 1200 may be used to implement the data collection and processing unit 136 of FIG. 1. The various blocks shown in FIG. 12 may be implemented using any desired combination of hardware (e.g., logic, processors, etc.) and/or software (e.g., machine readable and executable instructions or code). As shown, the system 1200 includes a map generator 1202 to generate radar maps using, for example, the process described in connection with FIG. 7. A tracker 1204 is also provided to perform, for example, the tracking process shown in FIG. 6. An identifier 1206 may cooperate with the tracker 1204 to identify unknown persons in accordance with the example identification process shown in FIG. 8. In operation, the tracker 1204 receives identification information from the identifier 1206. A login/logout unit 1208 enables persons entering or occupying the media environment being monitored to login/logout to/from the tracker 1204. The login/logout unit 1208 may be configured to perform its operations in accordance with the example login/logout processes shown and described in connection with FIGS. 10 and 11. A media associator 1210 cooperates with the tracker 1204 to, for example, perform the example media association process described in connection with FIG. 9. A communication unit 1212 is provided to enable the system 1200 to communicate with, for example, a central data collection facility (e.g., the facility 166 of FIG. 1). A radar device(s) interface 1214 is provided to couple the system 1200 to one or more radar devices (e.g., the devices 120, 122, 124, and 126 of FIG. 1). A data storage unit 1216 is provided to store tracking data, audience measurement data, biometric profile data, audience member identifiers, etc. The blocks 1202-1216 may be coupled via a data bus 1218 or in any other desired manner.

FIG. 13 is example processor-based system that may be used to implement the example radar-based audience measurement apparatus and methods described herein. The methods or processes described herein (e.g., the example processes depicted in FIGS. 5-11) may be implemented using instructions or code stored on a machine readable medium that, when executed, cause a machine to perform all or part of the methods. For example, the instructions or code may be a program for execution within by a processor, such as the processor 1300 within the example processor-based system 1302 depicted in FIG. 13. The program may be embodied in software stored on a tangible medium such as a CD-ROM, a floppy disk, a disk drive, a digital versatile disk (DVD), or a memory associated with the processor 1300, but persons of ordinary skill in the art will readily appreciate that the entire program and/or parts thereof could alternatively be executed by a device other than the processor 1300 and/or embodied in firmware or dedicated hardware in a well-known manner. For example, any or all of the blocks shown in FIG. 12, including the map generator 1202, the tracker 1204, the identifier 1206, the login/logout unit 1208, the media associator 1210, and/or the communication unit 1212 could be implemented by software, hardware, and/or firmware. Further, although the example program is described with reference to the flow diagrams illustrated in FIGS. 5-11, persons of ordinary skill in the art will readily appreciate that many other methods of implementing the methods described herein may alternatively be used. For example, the order of execution of the blocks may be changed, and/or some of the blocks described may be changed, eliminated, or combined.

Now turning in detail to FIG. 13, the example processor-based system 1302 may be, for example, a server, a personal computer, a personal digital assistant (PDA), an Internet appliance, a DVD player, a CD player, a digital video recorder, a personal video recorder, a set top box, or any other type of computing device.

The processor 1300 may, for example, be implemented using one or more Intel® microprocessors from the Pentium® family, the Itanium® family or the XScale® family. Of course, other processors from other families are also appropriate.

The processor 1300 is in communication with a main memory including a volatile memory 1304 and a non-volatile memory 1306 via a bus 1308. The volatile memory 1304 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1306 may be implemented by flash memory and/or any other desired type of memory device. Access to the memory 1304 is typically controlled by a memory controller (not shown) in a conventional manner.

The system 1300 also includes a conventional interface circuit 1310. The interface circuit 1310 may be implemented by any type of well-known interface standard, such as an Ethernet interface, a universal serial bus (USB), a third generation input/output (3GIO) interface, shared memory, an RS-232 compliant interface, an RS-485 compliant interface, etc.

One or more input devices 1312 are connected to the interface circuit 1310. The input device(s) 1312 permit a user to enter data and commands into the processor 1300. The input device(s) can be implemented by, for example, a keyboard, a mouse, a touchscreen, a track-pad, a trackball, isopoint and/or a voice recognition system.

One or more output devices 1314 are also connected to the interface circuit 1310. The output devices 1314 can be implemented, for example, by display devices (e.g., a liquid crystal display, a cathode ray tube display (CRT), a printer and/or speakers). The interface circuit 1310, thus, typically includes a graphics driver card.

The interface circuit 1310 also includes a communication device such as a modem or network interface card to facilitate exchange of data with external computers via a network 1316 (e.g., an Ethernet connection, a digital subscriber line (DSL), a telephone line, coaxial cable, a cellular telephone system, etc.).

The system 1302 also includes one or more mass storage devices 1318 for storing software and data. Examples of such mass storage devices include floppy disk drives, hard drive disks, compact disk drives and digital versatile disk (DVD) drives.

FIG. 14 is a block diagram of another system 1400 that may be used to implement the example radar-based audience measurement apparatus and methods described herein. As shown in FIG. 14, the system 1400 includes a radar system 1402, a biometric system 1404, and an audience tracking and measurement system 1406, all of which are coupled as shown. In general, the system 1400 provides a modular architecture in which any of a variety of radar systems and/or biometric systems may be coupled with an audience tracking and measurement system. In this manner, for example, different radar technologies and/or biometric input technologies may be used to suit the needs of particular applications, cost considerations, advances or changes in related technologies, system service requirements, system expansion requirements, etc. However, it should be understood that while example system architectures are provided in FIGS. 12, 13, and 14, any number of other architectures and/or arrangement of functional blocks could be used instead to achieve similar or identical results.

Turning in detail to FIG. 14, the radar system 1402 may be an ultra wideband system, which is one example of See-Thru-Wall technology and, thus, may include a plurality of transmitters, receivers, and/or transceivers that are strategically distributed throughout a media environment to be monitored. In operation, the radar system 1402 may receive biometric data and time data (e.g., time annotated biometric data, time information for synchronization purposes, etc.) from the biometric system 1404. The radar system 1402 may also receive commands and media cell state data (e.g., active/inactive status information) from the audience tracking and measurement system 1406. The radar system 1402 acquires radar information (e.g., as described in the foregoing examples) and uses that radar information to manage the tracking and identification of images, blobs, clusters, etc. representing monitored persons within the media environment being monitored. The radar system 1402 provides tracking (e.g., time annotated location information) and identity information to the to the audience tracking and measurement system 1406. The biometric system 1404 acquires biometric data (e.g., via biometric input devices) and may convey that biometric data together with time information to the radar system 1402 and the audience tracking and measurement system 1406. The biometric system 1404 may also receive commands from the audience tracking and measurement system 1406.

The audience tracking and measurement system 1406 may perform a variety of functions including, for example, the coordination of tracking processes such as one or more of the operations depicted in FIG. 6, media cell association operations such as one or more of the operations depicted in FIG. 9, login/logout operations such as one or more of the operations depicted in FIGS. 10 and 11, processing user commands, etc.

Thus, in view of the foregoing examples, in can be seen that the example apparatus and methods substantially reduce the human effort (e.g., pushing buttons, wearing tags and/or other devices) needed to perform media audience measurement. The system is substantially passive and unobtrusive system because no tags or other devices need to be worn or otherwise carried by the monitored persons. Further, the radar devices can be obscured from view so that monitored individuals are not reminded or otherwise made aware of being monitored.

In contrast to many known systems, the radar-based audience measurement apparatus and methods described herein can substantially continuously and passively track the movements of audience members as they move throughout their households. Additionally, the example apparatus and methods described herein can combine or integrate the use of location tracking information with biometric data and/or heuristic data to bridge any gaps (e.g., period during which a tracking lock is lost) in the location data for one or more audience members being tracked. More specifically, by combining location tracking and matching of radar image or blob behavior/characteristics to biometric data and/or heuristic data associated with individuals enables accurate identification and re-identification of people (i.e., re-linking or re-establishing links of identity information to blobs) to enable substantially continuous tracking and monitoring of persons moving throughout a monitored media environment such as a household.

While the apparatus and methods have been described in the foregoing detailed examples in connection with identifying media exposure (e.g., exposure to television programs, radio programs, etc.) within a household environment, the apparatus and methods described herein may be more generally applied to identify other types of environments and types of media. For example, the apparatus and methods described herein may be used to track the locations and/or movements (e.g., paths) of persons within a retail store environment to identify exposures of those persons to advertisements and other types of media typically found within such an environment. More specifically, the locations of persons may be determined and compared to known locations of media displays or areas such as point of purchase displays, aisle end cap displays, coupon dispensers, or other promotional and/or informational areas and/or objects distributed throughout the retail environment. In this manner, persons who are proximate or within a certain range or distance of such media displays or areas may be considered exposed to these displays or areas.

The media displays or areas may include any desired combination of visual and audio information. For example, printed signs, static video displays, moving or dynamic video displays, flashing lights, audio messages, music, etc. may be used to implement the media displays or areas. Further, each of the displays or areas may include a similar or different combination of visual and audio information as desired.

In some examples, the manner in which a person moves may also be used to determine whether a media exposure has occurred and/or the nature or quality of the media exposure. For example, if a person's movements are indicative of a type of movement that would typically not be associated with an exposure, then despite the person's location(s) being proximate to a media display or area, exposure to the media therein may not be credited. More specifically, if a person moves quickly past a point of purchase display or end cap of an aisle, then that person may not have consumed (e.g., read, viewed, listened to, etc.) the media information provided by the display or end cap. On the other hand, if a person's movements are indicative of lingering or pausing near a media display or area, then exposure to that media display or area may be very likely and, thus, credited.

The location, movement, and exposure data collected using the example systems and methods described herein within a retail environment including media displays or areas may be analyzed to identify more general patterns of behavior. For example, the effectiveness of certain media displays or areas may be assessed based on, for example, the numbers of persons that are determined to have been exposed to those media displays or areas, based on the amount of time (e.g., on average) that those persons spent in proximity to the media displays or areas, and/or the manner in which the persons moved (e.g., lingered, paused, etc.) when in proximity to the media displays or areas. Additionally, the data can be analyzed to determine whether changes to certain media displays or areas result in a change in the patterns of movement of persons within the environment. For example, if a media display (e.g., a point of purchase display, sale sign, coupon dispenser, etc.) is placed in an area that previously did not have a display, the movements of persons prior to installation of the display may be compared to the movements of persons following the installation of the display to determine if display may have had a meaningful or significant impact on the movements of persons within the environment (e.g., a retail store).

Alternatively or additionally, the locations and/or movements of persons may be analyzed to identify locations or areas within the environment that would be best suited or most effective for a media display or area. For example, locations or areas experiencing a relatively large amount of traffic (i.e., a large number of store patrons) and/or areas or locations at which persons typically move slowly or linger (e.g., near a checkout aisle) may be identified as locations or areas best suited for media displays or areas.

Still further, the location information collected using the systems and methods described herein may be used to prompt a person that is near a media display or area to view and/or otherwise interact with the media display or area. For example, a visual and/or audio message may be activated as the person approaches a media display or area. The visual and/or audio message may cause (e.g., invite, request, etc.) the person to interact with the media display or area by, for example, pushing a button, taking a coupon, pausing to view the display, or in any other manner that may be useful to determine that the person has likely been exposed and/or consumed the media being presented by the display or area.

The apparatus and methods described above that enable the identification of particular persons may also be employed within the above-described retail store or environment implementations. For example, persons entering the retail store or environment may be identified using biometric information (e.g., via a previously stored profile), via a keypad input in which the person enters their name or other identifying information, via a recognition of some other physical characteristic of the person (e.g., breathing pattern, pattern of movement, etc.) Alternatively or additionally, persons may be identified via, for example, an identifier tag, which they may carry and/or which may be associated with a shopping cart. The identifier tag may be a smart card or similar device that can be remotely read or detected using wireless communications. Such a tag may alternatively or additionally be scanned (e.g., optically) as the person enters the retail store or environment. In any event, once a person is identified, their radar image or blob may be identified and their movements may be tracked in a substantially continuous manner as they move throughout the retail store or environment.

Although certain methods and apparatus and articles of manufacture have been described herein, the scope of coverage of this patent is not limited thereto. To the contrary, this patent covers all methods, apparatus and articles of manufacture fairly falling within the scope of the appended claims either literally or under the doctrine of equivalents.

1. A method of identifying media exposure, comprising:
acquiring radar information associated with a person in a media environment;
determining a location of the person in the media environment based on the radar information; and
identifying media exposure based on the location of the person.

2. (canceled)

3. A method as defined in claim 2, wherein identifying the media exposure based on the location of the person comprises identifying at least one of a media display or area associated with the location of the person.

4. A method as defined in claim 3, further comprising crediting exposure to the media display or area based on a pattern of movement of the person.

5. (canceled)

6. A method as defined in claim 3, further comprising determining an effectiveness of the media display or the area based on the identified media exposure.

7. A method as defined in claim 1, further comprising identifying the person and associating the identity of the person with the radar information associated with the person.

8. (canceled)

9. (canceled)

10. (canceled)

11. (canceled)

12. A method as defined in claim 7, wherein identifying the person comprises using a previous location of the person to identify the person.

13. (canceled)

14. (canceled)

15. (canceled)

16. A method as defined in claim 1, wherein acquiring the radar information associated with the person in the media environment comprises obtaining a first radar map of the media environment when the person occupies the media environment and comparing the first radar map to a second radar map representative of the media environment when unoccupied by the person.

17. (canceled)

18. (canceled)

19. (canceled)

20. A method as defined in claim 1, wherein identifying the media exposure based on the location of the person comprises determining if the location of the person is associated with a plurality of media cells and identifying the media exposure based on a selected one of the media cells.

21. A method as defined in claim 20, wherein the selected one of the media cells is selected based on at least one of a status of the selected one of the media cells or a proximity of the person to a media presentation device associated with the selected one of the media cells.

22. A method as defined in claim 1, wherein acquiring the radar information associated with the person comprises acquiring a plurality of radar images of the person in the media environment.

23. A method as defined in claim 22, further comprising:
determining a plurality of locations of the person in the media environment based on the radar images;
identifying a movement of the person in the media environment based on the locations; and
identifying the media exposure based on the movement of the person.

24. A method as defined in claim 23, wherein identifying the media exposure based on the movement of the person comprises determining a relationship between the movement of the person and a type of media.

25. (canceled)

26. A method of identifying media exposure, comprising:
establishing a plurality of media cells within a media environment;
generating a plurality of radar images of the media environment;
tracking movement of a person among the media cells based on the radar images; and
identifying media exposure based on the movement of the person among the media cells.

27. A method as defined in claim 26, wherein establishing the media cells comprises establishing at least one of the media cells for each of a plurality of media presentation devices in the media environment.

28. A method as defined in claim 26, wherein tracking the movement of the person among the media cells based on the radar images comprises subtracting a static radar map from the radar images to generate difference images to track the movement of the person among the media cells.

29. A method as defined in claim 26, wherein identifying the media exposure based on the movement of the person among the media cells comprises identifying the media exposure for locations of the person corresponding to active ones of the media cells.

30. A method as defined in claim 26, wherein identifying the media exposure based on the movement of the person among the media cells comprises identifying the media exposure based on a pattern of movement of the person.

31. A system to identify media exposure, comprising:
a processing unit to be coupled to a radar device associated with a media environment, wherein the processing unit is to:
receive radar information from the radar device;
determine a location of the person in the media environment based on the radar information; and
identify media exposure based on the location of the person.

32. (canceled)

33. (canceled)

34. A system as defined in claim 31, wherein the processing unit is to identify the media exposure based on the location of the person by identifying at least one of a media display or area associated with the location of the person.

35. A system as defined in claim 34, wherein the processing unit is to credit exposure to the media display or area based on a pattern of movement of the person.

36. (canceled)

37. (canceled)

38. A system as defined in claim 31, further comprising a status monitor to determine the status of a media presentation device within the media environment and to send status information to the processing unit.

39. (canceled)

40. (canceled)

41. (canceled)

42. (canceled)

43. (canceled)

44. (canceled)

45. (canceled)

46. (canceled)

47. A system as defined in claim 31, wherein the processing unit is to use the radar information to determine the location of the person by obtaining a first radar map of the media environment when the person occupies the media environment and comparing the first radar map to a second radar map representative of the media environment when unoccupied by the person.

48. (canceled)

49. (canceled)

50. A system as defined in claim 31, wherein the processing unit is to identify the media exposure based on the location by determining if the location is associated with a plurality of media cells and identifying the media exposure based on a selected one of the media cells.

51. A system as defined in claim 50, wherein the selected one of the media cells is selected based on at least one of a status of the selected media cell or a proximity of the person to a media presentation device associated with the selected media cell.

52. A system as defined in claim 31, wherein the processing unit is to obtain a plurality of radar images of the person in the media environment based on the radar information.

53. A system as defined in claim 31, wherein the processing unit is to identify the media exposure based on the location of the person by determining a movement of the person and a relationship between the movement and a type of media.

54. A system to identify media exposure, comprising:
a radar device interface to receive radar information associated with a media environment;
a map generator to generate a plurality of occupant maps of the media environment;
a tracker to compare the occupant maps to a static map of the media environment to track movement of a person within the media environment; and
a media associator to associate at least one media cell to the movement of the person to identify media exposure.

55. A system as defined in claim 54, further comprising an identifier to determine the identity of the person.

56. (canceled)

57. (canceled)

58. A system to identify media exposure, comprising:
a radar system to collect radar information associated with a media environment;
a biometric system to collect biometric information from at least one person associated with the media environment; and
a tracking and measurement system to identify media exposure associated with the media environment based on the radar information and the biometric information.

59. A system as defined in claim 58, wherein the radar system is to collect a plurality of occupant maps of the media environment.

60. (canceled)

61. A system as defined in claim 58, wherein the tracking and measurement system is to credit the media exposure by comparing the radar information to media cell status information.
